(19) United States
(12) Patent Application Publication
(10) Pub. No.: US 2005/0279447 A1
(43) Pub. Date: Dec. 22, 2005

(54) Embossed card manufacturing

(75) Inventors: Bernard Lebrun, Racine (CA); Claude Turgeon, Rock Forest (CA); Pierre Jalette, Rock Forest (CA)

Correspondence Address: WILDMAN HARROLD ALLEN & DIXON, 225 WEST WACKER DRIVE, SUITE 2800, CHICAGO, IL, 60606, US

(73) Assignee: Quebecor World Graphica Inc.

(21) Appl. No.: 11/141,617

(22) Filed: May 31, 2005

Related U.S. Application Data
(60) Provisional application No. 60/575,403, filed on Jun. 1, 2004.

(30) Foreign Application Priority Data
May 30, 2005 (CA) 2,506,680

(51) Int. Cl. B32B 31/00; B29C 65/00

(52) U.S. Cl. 156/250; 156/510; 156/209

(57) ABSTRACT

The method and system are used for producing a plurality of identical cards initially integrated on a common plastic sheet. The sheet is first stamped to simultaneously create at least one stamp on each card, each stamp comprising at least one metallic foil layer adhering on one side of the sheet. Then, the sheet is embossed to create embossings over at least a majority of the stamps. Finally, the sheet is cut to create the individual cards. The method and the system are capable of manufacturing mass-produced cards at a low cost and a high production rate.

### CROSS-REFERENCE TO RELATED APPLICATION

This application claims the priority over U.S. patent application No. 60/575,403 filed Jun. 1, 2004, and entitled “Embossed Card Manufacturing”, the content of which is hereby incorporated by reference.

### BACKGROUND

The present invention relates to the manufacturing of plastic cards, more particularly embossed cards that are mass-produced. An example of application is the production of promotional cards, particularly cards that resemble a credit card.

Credit cards, or any similar cards, are generally made of a plurality of laminated layers that are initially produced as blank cards without any embossing. The embossing on the cards is then made using a machine that embosses the cards one by one. This process is used for uniquely identified cards, but also for plastic cards used for promotion or any other kind of use. It is therefore a very expensive and time consuming operation, particularly in the case of identical cards used for promotion where there is a large volume of cards to be produced and a low cost expectation from the purchasers.

There is clearly a need to provide a method and a system capable of manufacturing mass-produced cards at a low cost and at a high production rate.

### SUMMARY

It is an aspect of the present invention to provide a method of producing a plurality of identical cards initially integrated on a common plastic sheet, the method comprising the successive steps of:
stamping the sheet to simultaneously create at least one stamp on each card, each stamp comprising at least one metallic foil layer adhering on one side of the sheet;
embossing the sheet to simultaneously create embossings over at least a majority of the stamps; and
cutting the cards from the sheet.

It is also an aspect of the present invention to provide a system for producing a plurality of identical cards initially integrated on a corresponding common plastic sheet, the system comprising:
a stamping press to simultaneously create at least one stamp on each card of the sheet, each stamp comprising at least one metallic foil layer adhering on one side of the sheet;
an embossing press to simultaneously create embossings over at least a majority of the stamps on the sheet; and
a die cutter to cut the cards from the sheet.

These and other aspects of the present invention are described in the following detailed description of a preferred embodiment, which description is made with reference to the appended figures.

### BRIEF DESCRIPTION OF THE FIGURES

FIG. 1 is schematic side view illustrating a plastic sheet and a metallic foil provided in a stamping press;

FIG. 2 is a schematic enlarged view showing stamps on the plastic sheet;

FIG. 3 is a schematic side view of an embossing press in which a stamped sheet is provided;

FIG. 4 is an enlarged schematic view showing a stamping die and its corresponding counter-die; and

FIG. 5 is a schematic enlarged side view showing embossings with their corresponding stamps.

### DETAILED DESCRIPTION

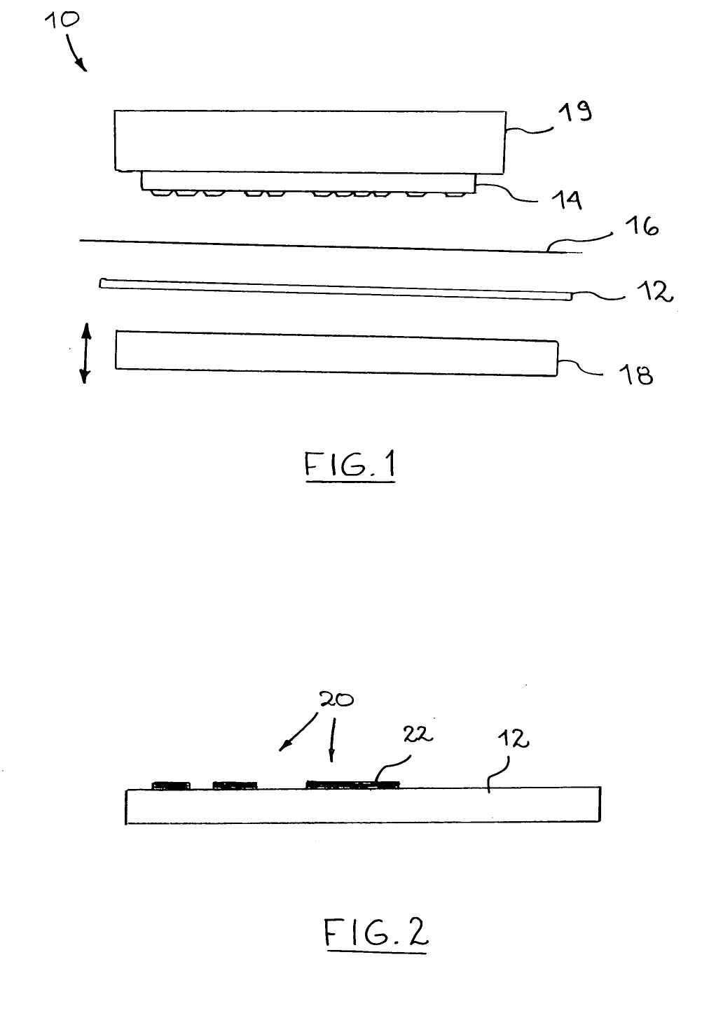

FIGS. 1, 3 and 4 schematically show an example of a system used for manufacturing cards. It should be noted that the term “card” used herein designates any plastic item which can be mass-produced with identical embossings from one item to another. Moreover, although mass-produced cards will all be identical after manufacturing, this does not exclude the possibility of having the cards further embossed using a conventional apparatus prior to shipment or use.

FIG. 1 shows an example of a stamping press (10) prior to the step of stamping the initial plastic sheet (12). This plastic sheet (12) integrates a plurality of cards, for instance seven rows of seven side-by-side cards (for a total of 49 cards). The sheet can be pre-printed or have an initial color. The stamping allows putting on the cards a very thin layer of metal foil used to enhance the visibility of embossings that will be later created on the cards. For instance, if the card is embossed with numbers and letters, the stamping can be used to create markings on the cards at the exact locations where the apex of the embossings will be located. Images can also be stamped and embossed as well.

In the illustrated embodiment, a thin metallic foil (16), such as one made of aluminum, is initially put between the plastic sheet (12) and a heated stamping plate (14). The plastic sheet (12) rests over a base (18), also referred to as a “bed”, which is vertically movable relative to the stamping plate (14). The stamping plate (14) is held by a supporting member (19).

When viewed from the bottom, the underside of the stamping plate (14) is the mirror of what will appear on the cards. The stamping plate (14) comprises a plurality of identical sections, each matching a corresponding card integrated on the plastic sheet (12). The stamping plate (14) typically has a thickness of 0.250 inch at the raised locations, its base having a typical thickness of about 0.180 inch. Other dimensions are also possible.

During stamping with the stamping press (10) of the illustrated embodiment, the base (18) moves upwards. This forces one side of the metallic foil (16) to make contact with the plastic sheet (12) at the raised locations of the stamping plate (14). The combination of heat and pressure forces the metallic foil (16) to adhere on the plastic sheet (12). The base (18) is later moved downwards to its original position. Generally, the metallic foil (16) can be used a number of times by offsetting its position so that the next stamping will not have any holes because of the absence of metallic foil.

FIG. 2 is a schematic enlarged view of the plastic sheet (12) with stampings (20). As can be seen, a metallic foil layer (22) was applied during the stamping, thereby forming a stamp on a surface of the sheet (12). It should be noted that the thickness of the parts is not to scale and has been exaggerated for the purpose of illustration. Also, it is possible to have more than one layer of metallic foil on the cards, depending on the design.

The next step is the embossing of the stamped plastic sheet (12). It is also made in a press. For greater efficiency, the embossings are done in an embossing press (30).

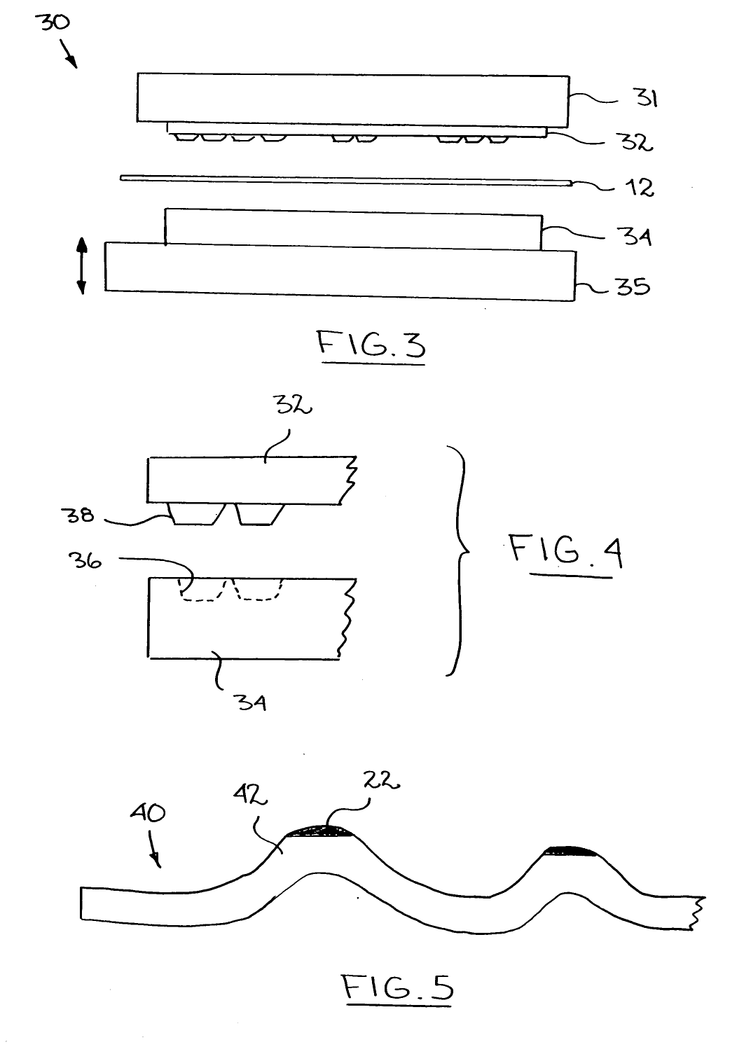

As shown in FIG. 3, the embossing press (30) of the illustrated embodiment uses a mounting plate (31) which supports a male embossing die (32). A female counter-embossing die (34) is located under the male embossing die (32), in registry therewith. This female embossing die (34) is supported by a base (35) and comprises cavities (36), all of which correspond to male projections (38) of the male embossing part (34), as shown in FIG. 4. The stamped plastic sheet (12) is located between the two embossing parts (32, 34) when the embossing press (30) is operated.

In use, the plastic sheet (12) is properly positioned, face down, on the female embossing die (34) so that all the stamps and the corresponding embossings will be coextensive, although it would be sufficient to create embossings on a majority of the stamps and leave some intact. Similarly, some embossings can be created where there are no stamps. Once in the embossing press, the female embossing die (34) is moved upwards, towards the male embossing die (32). Pressing both embossing dies (32, 34) together will create the embossings in the cards.

Once the embossing is completed, the stamped and embossed sheet can be cut into individual cards, for instance using a die cutter. Other kinds of cutting tools can be used as well.

FIG. 5 is a schematic enlarged view of a cross-section of a card after the stamping and the embossing. It shows that the card (40) has embossings (42), each having a metal foil layer (22) at the apex thereof.

As can be appreciated, the method and the system are very suitable for many applications, especially for mass-producing promotion cards, such as wallet-size cards.

It should be noted that the stamping press (10) and the embossing press (30) can be designed as a single machine. In that case, the dies can be made interchangeable to achieve the various steps 1t is also not required that the two presses (10, 30) or the steps of stamping and embossing be realized at the same plant or within a very close time frame.

1. A method of producing a plurality of identical cards initially integrated on a common plastic sheet, the method comprising the successive steps of:
stamping the sheet to simultaneously create at least one stamp on each card, each stamp comprising at least one metallic foil layer adhering on one side of the sheet;
embossing the sheet to simultaneously create embossings over at least a majority of the stamps; and
cutting the cards from the sheet.

2. The method as defined in claims 1, wherein the plastic sheet is pre-printed.

3. The method as defined in claim 1, wherein the metallic foil layer comprises aluminum.

4. The method as defined in claim 1, wherein at least some of the embossings form letters.

5. The method as defined in claim 1, wherein at least some of the embossings form numbers.

6. The method as defined in claim 1, wherein the embossings and the stamps are coextensive.

7. The method as defined in claim 1, further comprising:
removing the sheet from a first press immediately after the stamping and positioning it in a second press for the embossing.

8. The method as defined in claim 7, wherein the stamping and the embossing are accomplished in one stroke of the first and second press, respectively.

9. The method as defined in claim 1, wherein the cards are cut from the sheet using die cutting.

10. The method as defined in claim 1, wherein the cards are wallet-size promotional cards.

11. The method as defined in claim 1, further comprising the subsequent step of creating supplemental embossings in the individual cards.

12. The method as defined in claim 1, wherein the step of stamping the sheet comprises applying heat and pressure on the metallic foil disposed between the sheet and a stamping die.

13. The method as defined in claim 1, wherein the step of embossing the sheet comprises pressing the sheet between an embossing die and a counter-embossing die.

14. An individual card produced using the method as defined in claim 1.

15. A system for producing a plurality of identical cards initially integrated on a corresponding common plastic sheet, the system comprising:
a stamping press to simultaneously create at least one stamp on each card of the sheet, each stamp comprising at least one metallic foil layer adhering on one side of the sheet;
an embossing press to simultaneously create embossings over at least a majority of the stamps on the sheet; and
a die cutter to cut the cards from the sheet.

16. The system as defined in claims 15, wherein the plastic sheet is pre-printed.

17. The system as defined in claim 15, wherein the metallic foil layer comprises aluminum.

18. The system as defined in claim 15, wherein at least some of the embossings form letters.

19. The system as defined in claim 15, wherein at least some of the embossings form numbers.

20. The system as defined in claim 15, wherein the embossings and the stamps are coextensive.

21. The system as defined in claim 15, wherein the cards are wallet-size promotional cards.

22. The system as defined in claim 15, wherein the stamping press comprises means for applying heat and pressure on the metallic foil when the metallic foil is between the plastic sheet and a stamping die.

23. The system as defined in claim 15, wherein the embossing press comprises an embossing die and a corresponding counter-embossing die, at least one being movable with reference to the other.
